(19) United States
(12) Patent Application Publication
(10) Pub. No.: US 2016/0307157 A1
(43) Pub. Date: Oct. 20, 2016

(54) Methods and Systems for Crowdfunding a Project

(71) Applicant: John DeTitta, Fairport, NY (US)

(72) Inventor: John DeTitta, Fairport, NY (US)

(21) Appl. No.: 14/982,117

(22) Filed: Dec. 29, 2015

Related U.S. Application Data
(60) Provisional application No. 62/147,656, filed on Apr. 15, 2015.

(51) Int. Cl. G06Q 10/10; G06Q 20/10; G06Q 20/06; G06Q 50/00

(52) U.S. Cl. CPC G06Q 10/103; G06Q 50/01; G06Q 20/10; G06Q 20/065

(57) ABSTRACT

A method for online crowdfunding of a project including the steps of: (i) providing, by a computer system, a crowdfunding website configured to crowdfunding a project, the crowdfunding website hosting a plurality of crowdfunding projects to be funded by one or more of a plurality of service providers, the computer system comprising a web server hosting the crowdfunding website; (ii) receiving, from a project creator, a request to create a crowdfunding project, the request comprising a selection of a service provider; (iii) creating by the computer system, in response to the request, a crowdfunding project; (iv) receiving, from one or more users of the crowdfunding website, funding for the crowdfunding project; and (v) transferring, by a computer system, a portion of the received funding to the service provider, wherein the service provider provides funding to the project creator.

### CROSS-REFERENCE TO RELATED APPLICATIONS

This application claims priority to U.S. Provisional Patent Application Ser. No. 62/147,656, filed on Apr. 15, 2015 and entitled “Improved Methods and Systems for Crowdfunding a Project,” the entire disclosure of which is incorporated herein by reference.

### FIELD OF THE INVENTION

The present invention relates to methods and systems for crowdfunding a project in which the project creator selects an available service provider and an available package offered by that service provider.

### BACKGROUND

Crowdfunding is the pooling of money or resources from two or more people in order to support a particular project or goal. Due to the internet, crowdfunding has been made possible in more creative means and avenues than ever before. In 2013, for example, the crowdfunding industry was estimated to have raised more than $5 billion globally. Examples of crowdfunding projects include books, music, movies, and much more.

As an example, a project creator may use a crowdfunding website to raise funds for a new project. The project creator defines the project and sets a crowdfunding goal. The project information can include the background or purpose of the project, the goals of the project, and more. Successful projects will often include images or videos. The project creator often provides rewards for certain funding amounts. For example, at a first funding level the funder may receive a personal thank you; at a second funding level the funder may receive an advance copy of the project (art, music, movie, etc.); at a third funding level the funder may receive an offer to meet the project creator; and so on. Once the crowdfunding goal is met the crowdfunding website provides the funds (minus an administration fee) to the project creator, and the project creator can commence the project.

Current crowdfunding methods and systems provide the raised funds directly to the project creator. However, this can raise several concerns. For example, some people may be hesitant to provide funding for a project creator that they don't know. Similarly, there may be concerns about whether the project creator is actually receiving the full crowdfunded amount. Current crowdfunding methods and systems also create issues for the project creator. For example, instead of focusing on the project, the project creator must be concerned with money management.

Accordingly, there is a continued need for methods and systems that eliminate these and other concerns, and allow a project creator to receive funds without concerns about money management.

### SUMMARY OF THE INVENTION

The present disclosure is directed to methods and systems for crowdfunding a project in which a project creator receives the crowdfunded funds and/or resources from an available service provider via an available package offered by that service provider, rather than receiving funding directly. For example, when the project creator creates the project, they select from among a number of different service providers and then select an available package from the selected service provider. If the project is successfully funded, the crowdfunding entity provides the fund and/or resources to the service provider, and the service provider provides the funds and/or resources to the project creator. The project can be any project that requires funding. For example, the project can be an art project, theater project, college project,

According to an aspect is a method for crowdfunding a project comprising the steps of: (i) providing, by a computer system, a crowdfunding website configured to crowdfunding a project, the crowdfunding website hosting a plurality of crowdfunding projects to be funded by one or more of a plurality of service providers, the computer system comprising a web server hosting the crowdfunding website; (ii) receiving, from a project creator, a request to create a crowdfunding project, the request comprising a selection of a service provider; (iii) creating by the computer system, in response to the request, a crowdfunding project; (iv) receiving, from one or more users of the crowdfunding website, funding for the crowdfunding project; and (v) transferring, by a computer system, a portion of the received funding to the service provider, wherein the service provider provides funding to the project creator.

According to an embodiment, the method further comprises the steps of sending the request from the project creator to the service provider, and receiving, from the service provider, authorization to create the crowdfunding project.

According to an embodiment, the request from the project creator further comprises a selection of a service provider funding package option.

According to an embodiment, the method further includes the step of receiving, from the service provider, one or more service provider funding package options.

According to an embodiment, the crowdfunding project comprises a dedicated project webpage.

According to an embodiment, the step of receiving funding for the crowdfunding project comprises receiving confirmation indicating completion of one or more funding activities performed by the user.

According to an embodiment, the project is funded only if a predetermined funding goal is achieved.

According to an embodiment, the method further includes the step of returning a portion of the funding to the one or more users from whom funding for the crowdfunding project was received.

According to an embodiment, the funding comprises a virtual currency.

According to an aspect is a system for online crowdfunding of a project. The system includes: a plurality of service providers, each of the plurality of service providers configured to fund one or more crowdfunding projects associated with a crowdfunding website; a web server configured to host the crowdfunding website; a database in communication with the web server, the database comprising information about a plurality of users of the crowdfunding website, the plurality of service providers, and a plurality of crowdfunding projects; and a processor in communication with the web server and the database, the processor configured to: (i) receive, from a project creator, a request to create a crowdfunding project, the request comprising a selection of one of the plurality of service providers; (ii) create a crowdfunding project in response to the request from the project creator; (iii) receive, from one or more of the plurality of users of the crowdfunding website, funding for the crowdfunding project; and (iv) transfer a portion of the received funding to the service provider.

According to an aspect is a computer program product comprising a computer readable storage medium having program instructions to cause a computer to perform a method comprising the steps of: (i) providing, by a computer system, a crowdfunding website configured to crowdfunding a project, the crowdfunding website hosting a plurality of crowdfunding projects to be funded by one or more of a plurality of service providers, the computer system comprising a web server hosting the crowdfunding website; (ii) receiving, from a project creator, a request to create a crowdfunding project, the request comprising a selection of a service provider; (iii) creating by the computer system, in response to the request, a crowdfunding project; (iv) receiving, from one or more users of the crowdfunding website, funding for the crowdfunding project; and (v) transferring, by a computer system, a portion of the received funding to the service provider, wherein the service provider provides funding to the project creator.

These and other aspects of the invention will be apparent from reference to the embodiments described hereinafter.

### BRIEF DESCRIPTION OF THE DRAWINGS

The present invention will be more fully understood and appreciated by reading the following Detailed Description in conjunction with the accompanying drawings, in which:

FIG. 1 is a flowchart of a method for crowdfunding a project in accordance with an embodiment.

FIG. 2 is a representation of a system for crowdfunding a project in accordance with an embodiment.

### DETAILED DESCRIPTION

The present disclosure describes various embodiments of apparatus, systems, devices, and methods for crowdfunding a project in which a project creator receives the crowdfunded funds from an available service provider via an available package offered by that service provider, rather than receiving funding directly.

According to prior art funding methods, a project creator creates an account with a crowdfunding website. The project creator then uses the crowdfunding web site to create a project to be funded, including a funding goal. Members of the crowdfunding website donate money and/or resources to the project. When the funding goal is reached or exceeded, the crowdfunding website provides money to the project creator who can then begin work on the project. For the reasons discussed above, these prior art methods are inefficient and subject to serious problems.

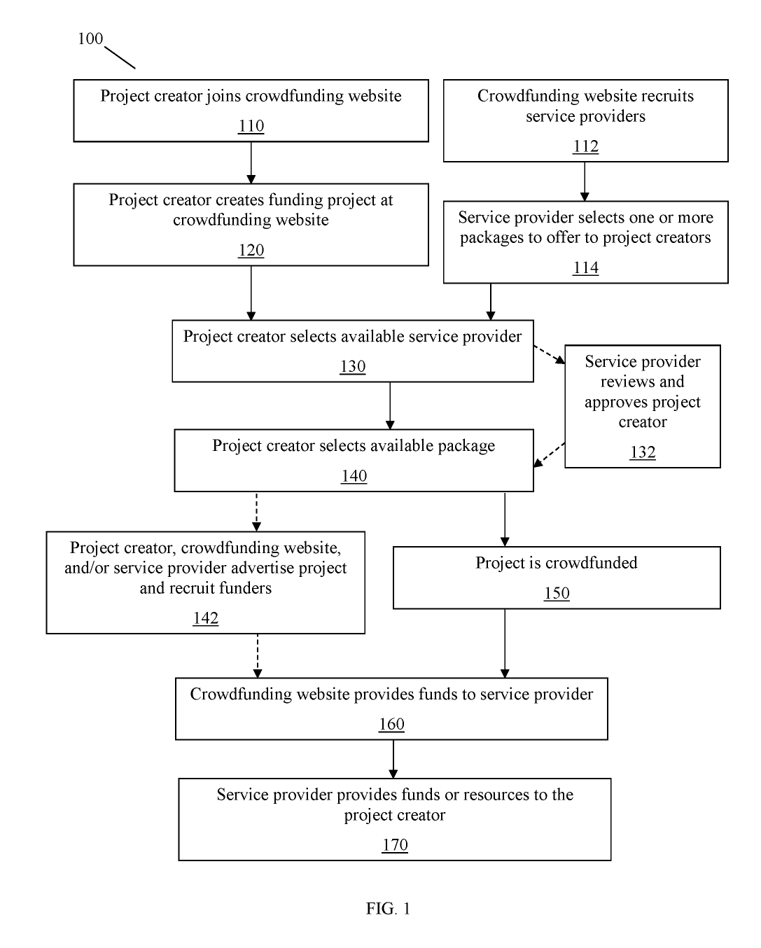

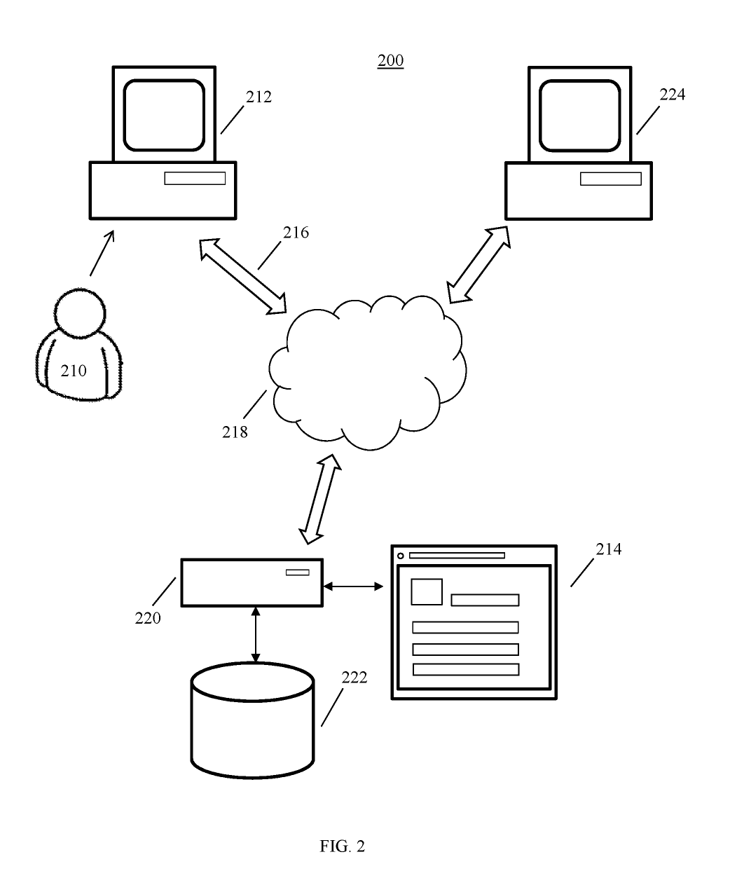

Referring to FIG. 1, in one embodiment, is a flowchart of a method 100 for crowdfunding a project. Similarly, referring to FIG. 2, in one embodiment, is a system 200 for using the method for crowdfunding a project. At step 110 of the method, a project creator 210 at computer 212 joins a crowdfunding website 214. The project creator can create a profile populated with any required and/or voluntary information such as name, biography, prior projects, and more. Computer 212, and any other computer disclosed or otherwise envisioned herein, can be any desktop computer, laptop, personal digital assistant, cellular telephone, smartphone, handheld device, and combinations thereof, including anything with a processor and a connection 216 to the computer network 218. The computer network 218 can be the Internet, and can also be any number of network systems known to those skilled in the art. For example, the computer network may be a combination of local area networks (LAN), wide area networks (WAN) and the like.

According to an embodiment, the crowdfunding website 214 can be an entity such as a company, partnership, or other business entity or organization that raises funds using a prior art method or one of the methods disclosed or otherwise envisioned herein. For example, the website can be hosted on a server 220 owned or leased by the crowdfunding entity, which will typically comprise one or more databases 222 with information about the members of the crowdfunding entity, project creators, service providers, service provider packages, and funding pledges, among other information.

At step 120 of the method in FIG. 1, project creator 210 creates a funding project. The project can be aimed at creating a new piece of art, music, a screenplay, novel, piece of machinery or other technology, or any of an almost limitless number of projects. To create the funding project, project creator 210 provides information including but not limited to the purpose or goals of the project, the background of the project, the future of the project, information about the members of the project, or other information.

At step 130 of the method, the project creator selects a service provider 224. The service provider is an entity that provides the funding for the project, and is refunded by the crowdfunding entity 214. For example, a service provider is a company, business, person, or other entity that provides product or services that the project creator needs, such as a music equipment company, a recording studio, a caterer for a film, an editor for film, a self-publishing company for literature, a manufacturer, and so on. The project creator may select from a list of service providers if multiple providers are available. The selection may be limited, for example, to only those service providers that provide funding or resources to the category of projects to which the new project belongs. Alternatively, a service provider may only provide funding to certain groups of individuals such as people from a certain geographic location, demographic, or other attribute. As yet another option, a service provider may only provide funding at certain times or dates.

In order to provide the project creator with options for funding, it may be necessary for the crowdfunding entity 214 to request, recruit, or otherwise gather service provider entities 224. At step 112 of the method, therefore, the crowdfunding entity 214 recruits one or more service providers. According to a preferred embodiment, the crowdfunding entity is able to recruit a plurality of service providers, thereby ensuring a greater likelihood that a project creator will be able to find a suitable service provider. When a service provider is added, the service provider can provide a selection of one or more packages at step 114. As described below, the packages are funding options that the project creator can select from when creating the funding project. The crowdfunding entity 214 may have a standard form for information about packages, or may be more adaptable to the type or variety of packages provided by each individual service provider.

At optional step 132 of the method, it may be necessary for the service provider to vet, review, or otherwise approve the project creator. For example, the service provider may review the background, biography, or other credentials of every project creator before authorizing a project. Or the service provider may only review the credentials of new project creators, for example. Once authorization for the project creator and/or project is granted by the service provider, the method can proceed to the next step.

At step 140 of the method, the project creator selects from among one or more possible funding packages. Typically, the selection of funding packages will be defined by the selected service provider. For example, service provider A may provide a first selection of funding packages and service provider B may provide a second selection of funding packages, and there may or may not be overlap between the first and second funding packages. According to an embodiment, a package may be a specific project category, service, or product. For example, the package may be music demo service for $5,000. As more examples, the package may be catering for a documentary for $2,500, self-publishing of a 250-page book for $250, 3D-printing with plastics up to 1 pound for $35 each, editing services for three cents a word, and many, many more.

At step 142 of the method, which is optional, the project creator, crowdfunding entity, and/or the service provider will advertise the project in order to recruit funders. For example, the project can be advertised on the internet properties belonging to any one of these entities. As another example, the crowdfunding entity and/or the service provider can provide a newsletter, blog, or other announcement mechanism for highlighting one or more projects. Any method of bringing awareness of the project to potential funders can be used. As one example, the crowdfunding entity and/or the service provider may only advertise the project to particular potential or past funders, such as those funders that are more likely to fund this category of project, which can be determined based on preferences or on past funding experiences.

At step 150 of the method, funders fund the project. This can be done by promising that a certain amount of funding or resources will be provided to the crowdfunding entity if the project is ultimately 100% (or more) funded, or the amount of funds or resources can be provided to the crowdfunding entity immediately.

According to one embodiment, individuals earn funding (such as virtual funding as discussed below), points, or a similar value component by engaging in activities that are rewarded by funding or points, awarded by either from the service provider and/or by one or more third-party entities. The user then donates the awarded or accumulated funding or points to a project, person, or category of interest. Optionally, the individual receives a portion or percentage of the funding or points. The user preferably creates an account with the service provider to track the funding, points, or other value component. According to an embodiment, for example, the user can earn points or funding by watching videos, searching the Internet, shopping online, completing tasks, answering questions, taking surveys, inviting friends, advertising, and many more activities. As another example, project creators and/or users can sell merchandise through the crowdfunding website and another forum associated with the crowdfunding website. Either a portion of the proceeds will be donated to projects, or users will convert cash to a crowdfunding website currency that is utilized to purchase merchandise, where at least a portion of the cash is utilized for projects. For each of these activities, the user earns points or funding. When the user turns over the points or funding to the site or to a project, the user can receive a reward such as a gift card, cash card, a membership, or any of a variety of other rewards. Points can thus have a value associated with them. For example, 500 points may be equivalent to a $5.00 gift or cash card.

According to an embodiment, the crowdfunding entity utilizes a virtual currency to fund a project. For example, the crowdfunding entity may utilize virtual currency x that is purchased by funders and potential funders. Typically, the funder or potential funder will purchase a certain amount of virtual currency x with government-issued or -approved currency. This can be done when the funder creates their account, at any time after the account is created, and/or at the time of promising or providing funding to the project. The amount of virtual currency x that can be purchased with government-issued or -approved currency may be static or may fluctuate based on events, factors, or aspects of or within the crowdfunding entity or one or more of the service providers. The crowdfunding entity may require some administrative fee when converting the government-issued or -approved currency to the virtual currency x, and/or vice versa.

Thus, when a project creator selects a package, the crowdfunding entity or the service provider may convert the cost of the package to the virtual currency x and display that amount rather than the government-issued or -approved currency amount. For example, if the project creator selects package 4 from service provider B, which is 3D-printing of a 5-pound object for $250, then the crowdfunding entity or the service provider may convert the cost of $250 to the equivalent amount of virtual currency x which might be, for example, 5,000 tokens, or 300 x's, or any of a wide variety of options. The project website will then display the need for 300 x's, for example, and funders and provide or promise a certain number of the x's in their own account. Once promised or provided, for example, the funder's profile may immediately reflect that the promised or provided amount of x's have been removed or have been set aside for the project.

At steps 160 and 170, which can be performed in any order (as can several of the other steps described above), once the project has been fully or adequately funded then funding and/or resources are exchanged. There may be a requirement set forth by the crowdfunding entity, the service provider, and/or the project creator that a project is only funded if the requested amount is achieved, or only funded if the requested amount is achieved within a certain timeframe, or only funded if the requested amount is achieved by a certain number of funders, or any of a variety of other requirements. There may also be no such requirement, such that the project receives any and all funding provided. Additionally, the project may end if no funding is received within a certain time frame. As another option, there may be an option set forth by the crowdfunding entity, the service provider, and/or the project creator that a project is ended as soon as the goal is reached. For other projects, one or more of the entities may determine that the project can continue for a certain time regardless of whether the funding goal is reached and exceeded.

For example, at step 160, the goal is reached and the crowdfunding website provides funds to the service provider. This is because at step 170, it is the service provider and not the crowdfunding website that provides the funding and/or resources directly to the project creator. Providing the funds and/or resources to the service provider at step 160 may include the step of converting the virtual currency to a more standard government-issued or -approved currency.

The benefits of this improved system are immediately clear. For example, the service provider may provide a service rather than money to the project creator, in which case the additional steps of the crowdfunding entity providing money to the project creator, who then has to negotiate with an outside service provider, are eliminated. Instead of worrying about finding a suitable service provider at a suitable price, the project creator is immediately ready to work with the selected—and now funded—service provider as soon as the project is funded.

As one example of the method, a project creator 212 would like to record music in a studio. The project creator joins the crowdfunding entity and would like to create a project to raise money for three (3) days' worth of work with a professional music studio. The project creator selects among a list of 25 music studios that provide services using the crowdfunding entity, ultimately selecting a music studio nearby. That music studio offers a package for three days' work worth virtual currency $2000x (approximately $5,000), and the musician selects that package. A project website is created and displayed by the crowdfunding entity. The project creator provides links through her social media accounts for the website, as does the crowdfunding entity and the service provider (the nearby music studio). The crowdfunding entity highlights the project in its weekly e-newsletter, and the music studio describes the project on physical bulletin boards and on its website, among many other places. Over the course of the next 30 days, more than $2200x is raised, and the project ends on the 30^{th} day as planned. The funders all provide their promised amount of x to the crowdfunding entity. The accumulated or gathered $2200x is converted to approximately $5,500 USD which is then provided by the crowdfunding entity directly to the music studio, minus administrative fees for the crowdfunding entity. The music studio contacts the musician and schedules three days' worth of work, plus editing.

There is no limit to the variety of different projects that could be funded utilizing the projects and systems disclosed herein. Any project that can be described and associated with the crowdfunding website, and that can potentially recruit from users, can be utilized in the crowdfunding method. Typically, a project has well-defined objectives and goals such as recording a song, writing a book, creating a painting, or producing a film. A project can also be something that will be completed with the end result of something tangible being produced. The crowdfunding website may optionally prohibit certain projects if they comprise objectionable material or goals such as pornographic material, drug-related material, hate material, sweepstakes, and other objectionable projects. Accordingly, it may be necessary for the crowdfunding website to comprise an authorization step, in which one or more reviewers review a project submission and must approve the submission before it can be funded or advertised. The crowdfunding website may also comprise a periodic review in order to prevent or remove objectionable material. Additionally, the crowdfunding website may also comprise a notification system in which users of the site can notify the crowdfunding website administrators to objectionable content which the administrators can then review and curate, remove, or otherwise address.

As just one example of a project that could be funded, an engaged couple who are getting married at a future date creates a funding project to fund their wedding. The couple select an available “wedding funding” package from among a list of service providers who offer wedding funding services, and who then reviews and approves the project. The project is then crowdfunded in whole or in part by users of the crowdfunding website. For example, the engaged couple may send out requests to friends and members of their family to join the crowdfunding website. The crowdfunding website provides the funds to the service provider, and the service provider provides the funds to the project creator. The user also receives a reward for creating and donating the funding to the project.

As another example of a project that could be funded, a high school senior who is headed to college in the Fall creates a funding project to fund her college education. She selects an available “college funding” package from among a list of service providers who offer college funding services, who then reviews and approves the project. The project is then crowdfunded in whole or in part by users of the crowdfunding website. The crowdfunding website provides the funds to the service provider, and the service provider provides the funds to the project creator. The user also receives a reward for creating and donating the funding to the project.

As another example of a project that could be funded, an author who is working on or would like to work on a new book creates a funding project to fund her new book project. She selects an available “book funding” package from among a list of service providers who offer book funding services. The author advertises her project to friends, family, and previous readers of her other books, and they join the crowdfunding website, engage in fundraising activities, and thus crowdfund the project. The crowdfunding website provides the funds to the service provider, and the service provider provides the funds to the project creator. The user also receives a reward for creating and donating the funding to the project.

Many, many other projects are possible.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments of the described subject matter can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

What is claimed is:

1. A method for online crowdfunding of a project, the method comprising the steps of:
providing, by a computer system, a crowdfunding website configured to crowdfunding a project, the crowdfunding website hosting a plurality of crowdfunding projects to be funded by one or more of a plurality of service providers, the computer system comprising a web server hosting the crowdfunding website;
receiving, from a project creator, a request to create a crowdfunding project, the request comprising a selection of a service provider;
creating by the computer system, in response to the request, a crowdfunding project;
receiving, from one or more users of the crowdfunding website, funding for the crowdfunding project; and
transferring, by a computer system, a portion of the received funding to the service provider, wherein the service provider provides funding to the project creator.

2. The method of claim 1, further comprising the steps of:
sending the request from the project creator to the service provider; and
receiving, from the service provider, authorization to create the crowdfunding project.

3. The method of claim 1, wherein the request from the project creator further comprises a selection of a service provider funding package option.

4. The method of claim 3, further comprising the step of receiving, from the service provider, one or more service provider funding package options.

5. The method of claim 1, wherein the crowdfunding project comprises a dedicated project webpage.

6. The method of claim 1, wherein the step of receiving funding for the crowdfunding project comprises receiving confirmation indicating completion of one or more funding activities performed by the user.

7. The method of claim 1, wherein the project is funded only if a predetermined funding goal is achieved.

8. The method of claim 1, further comprising the step of returning a portion of the funding to the one or more users from whom funding for the crowdfunding project was received.

9. The method of claim 1, wherein the funding comprises a virtual currency.

10. A system for online crowdfunding of a project, the system comprising:
a plurality of service providers, each of the plurality of service providers configured to fund one or more crowdfunding projects associated with a crowdfunding website;
a web server configured to host the crowdfunding website;
a database in communication with the web server, the database comprising information about a plurality of users of the crowdfunding website, the plurality of service providers, and a plurality of crowdfunding projects;
a processor in communication with the web server and the database, the processor configured to: (i) receive, from a project creator, a request to create a crowdfunding project, the request comprising a selection of one of the plurality of service providers; (ii) create a crowdfunding project in response to the request from the project creator; (iii) receive, from one or more of the plurality of users of the crowdfunding website, funding for the crowdfunding project; and (iv) transfer a portion of the received funding to the service provider.

11. The system of claim 10, wherein the processor is further configured to send the request from the project creator to the service provider, and further configured to receive, from the service provider, authorization to create the crowdfunding project.

12. The system of claim 10, wherein the request from the project creator further comprises a selection of a service provider funding package option.

13. The system of claim 10, wherein the processor is further configured to receive, from the service provider, one or more service provider funding package options.

14. The system of claim 10, wherein receiving funding for the crowdfunding project comprises receiving confirmation indicating completion of one or more funding activities performed by the user.

15. The system of claim 10, wherein the project is funded only if a predetermined funding goal is achieved.

16. The system of claim 10, wherein the processor is further configured to return a portion of the funding to the one or more users from whom funding for the crowdfunding project was received.

17. The system of claim 10, wherein the funding comprises a virtual currency.

18. A computer program product for online crowdfunding of a project, the computer program product comprising a computer readable storage medium having program instructions to cause a computer to perform a method comprising:
providing, by a computer system, a crowdfunding website configured to crowdfunding a project, the crowdfunding website hosting a plurality of crowdfunding projects to be funded by one or more of a plurality of service providers, the computer system comprising a web server hosting the crowdfunding website;
receiving, from a project creator, a request to create a crowdfunding project, the request comprising a selection of a service provider;
creating by the computer system, in response to the request, a crowdfunding project;
receiving, from one or more users of the crowdfunding website, funding for the crowdfunding project; and
transferring, by a computer system, a portion of the received funding to the service provider, wherein the service provider provides funding to the project creator.

19. The computer program product of claim 18, further comprising the steps of:
sending the request from the project creator to the service provider; and
receiving, from the service provider, authorization to create the crowdfunding project.

20. The computer program product of claim 18, wherein the step of receiving funding for the crowdfunding project comprises receiving confirmation indicating completion of one or more funding activities performed by the user.
